(19) United States
(12) Patent Application Publication
(10) Pub. No.: US 2026/0365909 A1
(43) Pub. Date: Nov. 19, 2026

(54) SEALANT COMPOSITIONS COMPRISING DATE PALM SEEDS, SUBTERRANEAN OPERATION FLUIDS THEREOF, AND RELATED METHODS

(71) Applicant: SAUDI ARABIAN OIL COMPANY, Dhahran (SA)

(72) Inventors: Ayman ALMOHSIN, Dhahran (SA); Mohammed K. ARFAJ, Dhahran (SA); Aqeel ALSHAKHOURI, Dhahran (SA); Abdullah ALSHAMMASI, Dhahran (SA)

(73) Assignee: SAUDI ARABIAN OIL COMPANY, Dhahran (SA)

(21) Appl. No.: 19/208,919

(22) Filed: May 15, 2025

(51) Int. Cl. C09K 8/504

(52) U.S. Cl. CPC C09K 8/5045

(57) ABSTRACT

A method and a sealant composition for reducing lost circulation during drilling a wellbore and/or for cementing a wellbore. Sealant compositions comprise date palm seed particles; and an activated colloidal silica gel, a colloidal silica and an alkaline activator, or any combination thereof, where the sealant composition is capable of curing upon heating to form a solidified sealant composition. Methods comprise introducing said sealant composition into a wellbore within a subterranean formation; heating the sealant composition; and allowing the sealant composition to cure to form the solidified sealant composition.

### FIELD OF THE DISCLOSURE

The present disclosure relates generally to sealant compositions, subterranean operation fluids thereof, and related methods; more particularly, the present disclosure relates to sealant compositions comprising date palm seed particles and an activated colloidal silica gel, subterranean operation fluids thereof, and related methods.

### BACKGROUND OF THE DISCLOSURE

The production of crude oil and other hydrocarbons begins with the drilling of a wellbore through a subterranean formation and into a hydrocarbon reservoir. Drilling of a wellbore generally involves circulating a drilling fluid (or drilling mud) from a surface location of the wellbore to a downhole location through a drill string. The drilling fluid exits through ports (or jets) in a drill bit, which bores through the formation and forms the wellbore. The drilling fluid aids in cooling and lubricating the drill bit and further picks up cuttings and carries the cuttings up an annulus (also referred to herein as an annular area) formed between an inner wall of the wellbore and an outer wall of the drill string. The drilling fluid and the cuttings flow through the annulus to the surface, where the cuttings are separated from the fluid. For various environmental, sustainability, and practical reasons, aqueous-based drilling fluids may be preferred for wellbore drilling operations.

The wellbore may be isolated from the surrounding subterranean formation using a cementing operation. During a cementing operation, a cement sheath is placed within a wellbore between the subterranean formation and a casing. The cement sheath is formed by pumping a cement slurry down into the casing interior, out through the bottom end of the casing, and up into the annulus between the exterior casing wall and the formation face of the wellbore. The cement slurry then cures in the annular space, thereby forming a sheath of hardened cement that, among other functions, supports and positions the casing in the wellbore and bonds the exterior surface of the casing to the subterranean formation. The cement also prevents hydrocarbon fluid from flowing uphole from a hydrocarbon producing zone to the surface and in the annulus between the casing and the wellbore wall. Without the cement, or in instances when cement has failed, hydrocarbons are known to migrate to the surface and then present a safety hazard to operations personnel.

Cement slurries used in the oil and gas industry include primary, remedial, squeeze, and plug cementing techniques to place cement sheaths, for instance, in an annulus between a tubular (e.g., a casing) and a wall of the wellbore, for well repairs, well stability, or for well abandonment (i.e., sealing an old well to eliminate safety hazards). These cement slurries should be able to consistently perform throughout operations (e.g., pumping) and over a wide range of temperatures and conditions as cement cure in an oil and gas well may be vulnerable to radial stresses imposed by pressure and temperature fluctuations. Such vulnerability, depending on its severity, may result in mechanical failure. After mechanical failure, an expensive remedial operation like squeezing resin or micro-cement may be required to repair cracks in the wellbore cement sheath. Inadequate sealing of the original cracks or inadequate remedial operations may cause a fire hazard, an environmental hazard, a lack of zonal isolation, or a loss of pressure behind casing. Depending on the severity, these risks may lead to catastrophic accidents, failures, or well-abandonment.

The transition between a drilling operation and a cementing operation may further result in various issues that require additional remedial steps, such as for example, operator costs associated with time, economic expenditures, and equipment wear and tear. For example, after performing a drilling operation, residual aqueous-based drilling fluid may remain within the drilled wellbore, presenting significant challenges related to, for example, zonal isolation due to unstable and/or poor cement bonding, mud channeling, or other fluid migration-related interferences.

Indeed, fluid loss (or lost circulation) is a common form of such residual drilling fluid, in which the drilling fluid is imbibed or otherwise seeps into the pore matrix of a subterranean formation. Fluid loss may occur in various subterranean formations, such as naturally fractured formations, cavernous formations, and highly permeable formations (e.g., formations having a permeability greater than 500 millidarcy), regardless of the wellbore geometry (e.g., horizontal, vertical, deviated, or otherwise tortuous). While some fluid loss is expected, excessive fluid loss is not desirable from a safety, an economical, or an environmental point of view. Lost circulation is associated with problems with well control, borehole instability, pipe sticking, unsuccessful production tests, poor hydrocarbon production after well completion, and formation damage due to plugging of pores and pore throats by mud particles. In extreme cases, lost circulation problems may force abandonment of a well.

Lost circulation may be categorized by the amount of fluid or mud lost as seepage type, moderate type, severe type, and total loss. The extent of the fluid loss and the ability to control the lost circulation using lost circulation materials (“LCMs”) depends on the formation type where lost circulation occurs. One method that has been developed to control lost circulation involves the placement of LCMs into a lost circulation zone (i.e., the sections of a formation into which drilling fluid may be lost). Conventional LCMs may include fibrous, lamellated or granular materials. For a number of reasons, use of LCMs may not provide a desirable level of lost circulation control in all circumstances. In view of the aforementioned, a need exists for an ecologically and economically friendly sealant system for use in the oil and gas industry with improved fluid loss control and/or cement sheath stabilization during subterranean operations.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to various embodiments consistent with the present disclosure, methods are provided, comprising: introducing a sealant composition into a wellbore within a subterranean formation; wherein the sealant composition comprises: date palm seed particles; and an activated colloidal silica gel, a colloidal silica and an alkaline activator, or any combination thereof; heating the sealant composition; and allowing the sealant composition to cure to form a solidified sealant composition.

According to various embodiments consistent with the present disclosure, sealant compositions are provided, comprising: date palm seed particles; and an activated colloidal silica gel, a colloidal silica and an alkaline activator, or any combination thereof; wherein the sealant composition is capable of curing upon heating to form a solidified sealant composition.

Any combinations of the various embodiments and implementations disclosed herein may be used in a further embodiment, consistent with the disclosure. These and other aspects and features may be appreciated from the following description of certain embodiments presented herein in accordance with the disclosure and the accompanying drawings and claims.

### BRIEF DESCRIPTION OF THE DRAWINGS

To easily identify the discussion of any particular element or act, the most significant digit or digits in a reference number refer to the figure number in which that element is first introduced.

FIG. 1 shows a schematic illustration of lost circulation zones within a subterranean formation wherein the loss events may occur, e.g., through natural fractures, as described below in the Examples.

FIG. 2 shows a schematic illustration of a subterranean formation in which a date palm seed-silica composite is formed within a lost circulation zone for use as a lost circulation material, as described below in the Examples.

FIG. 3 shows date palm seeds before and after crushing and sieving to form date palm seed particles, as described below in the Examples.

FIG. 4 shows colloidal silica and an alkaline activator before and after reaction to form activated colloidal silica gel, as described below in the Examples.

FIG. 5 shows a sealant composition comprising date palm seed particles held under vacuum to absorb activated colloidal silica gel, as described below in the Examples.

FIG. 6 shows the date palm seed-silica composite which was pushed out of the cylinder in one piece without any breakage after the leak-off test, indicating that the date palm seed-silica composite is a rigid material, as described below in the Examples.

FIG. 7 shows the viscosity at 200 °F vs. time for sealant compositions comprising differing alkaline activator concentrations, as described below in the Examples.

FIG. 8 shows the proposed date palm seed-silica composite after curing, as described below in the Examples.

### DETAILED DESCRIPTION

Embodiments of the present disclosure will now be described in detail with reference to the accompanying Figures. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments of the present disclosure generally relate to well drilling and, more specifically, to compositions and methods for preventing lost circulation within and/or cementing the wellbore. The stability of cement sheaths as well as lost circulation to subterranean formations are each challenges during oil and gas operations that cause significant amounts of non-productive time and increase the cost of hydrocarbon production.

In an aspect, the present disclosure provides improved sealant compositions and related methods for mitigating fluid flow into lost circulation zones within a subterranean formation, where the sealant is capable of acting as a lost circulation material (“LCM”) during drilling operations, as a cementing material during cementing operations, the like, and any combination thereof. In various embodiments, the sealant compositions are suitable for sealing subterranean formations having diverse types of lost circulation zones. Sealant compositions as disclosed herein provide an improved, environmentally acceptable, customized high-performance system that may be used in water-based mud systems and oil-based mud systems, enabling wells to be drilled with high pressure/high temperature wells, while reducing fluid loss into subterranean formations.

In a further aspect, the present disclosure provides sealant compositions and related methods for forming cement sheaths within an annulus of a wellbore, during primary, remedial, squeeze, or plug cementing techniques, the like, or any combination thereof. Sealant compositions as disclosed herein may further be used as cement slurries to position and stabilize a casing within a wellbore, while preventing the flow of fluids between subterranean formations between a subterranean formation and the surface, as well as preventing gas or fluids from migrating to the surface. This newly designed system helps the operator increase operational efficiency by minimizing the risk of differential sticking, reducing downhole losses, improving wellbore stability, and reducing the cost of chemical usage, while also being an eco-friendly material.

As used herein, the term “subterranean formation,” and grammatical variants thereof, refers to naturally occurring rock beneath the Earth's surface, including subsea surfaces. As used herein, the terms “formation matrix,” “matrix,” and grammatical variations thereof, refer to the variety of natural rock which makes up a subterranean formation, including, but not limited to, carbonate-based rock (e.g., calcium carbonate (CaCO₃)), calcium magnesium carbonate (CaMg(CO₃)₂) (also referred to as dolomite), sandstone-based rock comprising clays (e.g., smectite, illite, kaolinite, chlorite, and the like), each of which include minerals (e.g., siliceous material) the like, and any combination thereof. The subterranean formations described herein encompass reservoir zones (i.e., zones comprising hydrocarbons, also referred to herein as “hydrocarbon reservoirs”) and non-reservoir zones (i.e., zones that do not include hydrocarbons, such as water-producing zones).

As used herein, the terms “subterranean operation,” “upstream operation,” and grammatical variants thereof, refer to any operation (e.g., drilling, completion, stimulation, enhanced recovery, production, and waste storage) involved in production of petroleum, natural gas, as well as other resources, such as water or helium, from a subterranean formation. A subterranean formation may contain an existing injection well, an existing production well, or a deep abandoned shallow single and/or multi-lateral well.

As used herein, the terms “well,” “wellbore,” and grammatical variants thereof, refer to a drilled hole or borehole penetrating a subterranean formation, which may be cased (cemented) or uncased (open hole). A wellbore may be of any geometry, including vertical, horizontal, deviated, or otherwise tortuous.

As used herein, the term “downhole,” and grammatical variants thereof, refers to the subsurface point of greatest penetration or depth in a wellbore.

As used herein, the term “subterranean operation fluid,” and grammatical variants thereof, refers to gaseous fluids, aqueous or oil-based liquids, and/or aqueous or oil-based muds suitable for use in subterranean operations in subterranean formations. For example, a drilling operation may use a liquid-based or mud-based drilling fluid, a cementing operation may use a cement slurry, a fluid loss control operation may use a liquid-based or mud-based drilling fluid or a drilling pill, or an enhanced recovery operation may include a fracturing fluid.

As used herein, the term “lost circulation zone,” and grammatical variants thereof, refers to a location within a wellbore in which undesirable fluid loss occurs into a subterranean formation. A lost circulation zone may encompass an area encountered during various subterranean formation operations (e.g., drilling operations, cementing operations) where a volume of a treatment fluid is lost into a subterranean formation and out of the wellbore. A rate of loss of 1 to 10 barrels per hour (bbl/h) is characterized as seepage-loss that may occur in any formation; a rate of loss of 10 to less than 500 bbl/h is characterized as moderate-loss that may occur in porous formations or those having relatively small natural or induced fractures; and a rate of loss of equal to or greater than 500 bbl/h is characterized as severe-loss that may occur in highly permeable formations or those having relatively large natural or induced fractures. Severe-loss may include total fluid loss and may result in complete abandonment of a well.

As used herein, the term “formation temperature conditions,” and grammatical variants thereof, refers to downhole temperature conditions, i.e., temperature conditions of from 49 °C (120 °F) to about 204 °C (400 °F), including all temperature values and subranges therebetween (e.g., at least about 66 °F (150 °F), at least about 93 °C (200 °F), at least about 121 °C (250 °F), at least about 149 °C (300 °F), or at least about 177 °C (350 °F), or from about 66 °F (150 °F) to about 177 °C (350 °F), or from about 93 °C (200 °F) to about 149 °C (300 °F), or from about 121 °C (250°F)).

### Sealant Compositions

Sealant compositions of the present disclosure may incorporate at least two main components: date palm seed particles and activated colloidal silica gel (wherein the activated colloidal silica gel may be in the form of a precursor material). In various embodiments, sealant compositions of the present disclosure may be capable of setting upon heating to form solidified sealant compositions. In some instances, solidified sealant compositions may be formed within a zone of interest in a subterranean formation and may be capable of mitigating a flow of a fluid from a wellbore into the subterranean formation. Solidified sealant compositions may generally be formed within an annulus between a wellbore wall and a casing (also referred to herein as a casing string).

In various embodiments, sealant compositions may be flowable upon activation for a sufficient time, e.g., a sufficient time for pumping of said sealant compositions and/or for use of said sealant compositions for drilling operations, cementing operations, for fluid loss control operations, the like, and any combination thereof. Sealant compositions of the present disclosure may be flowable for a sufficient time, e.g., suitable for pumping, use during drilling operations in a wellbore, use during cementing operations, use during fluid loss control operations, use during enhanced recovery operations, the like, and any combination thereof. After a sufficient time, sealant compositions of the present disclosure may be cured to a semi-solid or solid state capable of sealing lost circulation zones in a subterranean formation, cementing the annulus of the wellbore, or any combination thereof.

As used herein, the terms “flowable,” “flowability,” and grammatical variants thereof, refer to the ability of sealant compositions of the present disclosure to be pumped and to flow into a wellbore, as required for use as a drilling fluid, a cementing fluid, the like, or any combination thereof. Flowable sealant compositions may be characterized as a flowable liquid-phase that may include various solid and/or gaseous states of matter dispersed throughout which flow with the flowable liquid-phase. The flowability of sealant compositions may be determined by measuring various rheological properties of the sealant compositions.

Flowable sealant compositions of the present disclosure may be in an inactivated state. As used herein, the terms “inactivated,” “inactivated state,” and grammatical variants thereof, specifically in regard to a sealant composition, refers to a sealant composition of the present disclosure in which substantial curing or other polymerization reactions have yet to occur. As used herein, the terms “cure,” “curing,” and grammatical variations thereof, refer to polymerization and/or crosslinking reactions occurring between activated colloidal silica gel, precursors thereof, or any combination thereof, with date palm seed particles, leading to rigid date palm seed particle-silica composites. As used herein, the term “substantial,” and grammatical variants thereof, generally refers to an amount of curing or other polymerization reactions that produces a change of greater than 5 percent (5%) in any property (e.g., weight percent (wt. %), rheology, density, the like, or any combination thereof). As used herein, unless otherwise indicated, a property of a sealant composition, or of any component thereof, (i.e., wt. %, rheology, density, or the like) will refer to the property before substantial curing has occurred.

As used herein, the terms “activated,” “activated state,” and grammatical variants thereof, specifically in regard to a sealant composition, refer to a sealant composition of the present disclosure in which a substantial curing reaction has occurred within a sealant composition by contact of the activated colloidal silica gel, precursors thereof, or any combination thereof, with date palm seed particles, and/or by loss, removal, and/or inhibition of any cure retarding agents, and/or by addition of one or more accelerators capable of accelerating the curing reaction, and/or by subjecting an inactivated sealant composition to heat (e.g., at room temperature or above, e.g., at 100 °F or above, at formation temperature conditions (e.g., from about 120 °F to about 400 °F) or above).

In various embodiments, precursors of the activated colloidal silica gel may comprise an inactivated colloidal silica and an alkaline activator. As used herein, the terms “inactivated,” “inactivated state,” or grammatical variations thereof, specifically in regard to a colloidal silica, refer to a colloidal silica of the present disclosure which has yet to be activated by an alkaline activator, either by prevention of contact between the precursors; by addition of one or more gel retarding agents capable of preventing, delaying, or inhibiting a gelling reaction between the precursors; or by insufficient passage of time after contact of the precursors has been made, such that substantial gelling has not occurred. As used herein, the terms “gel,” “gelling,” and grammatical variations thereof, specifically in regard to colloidal silica, refer to crosslinking reactions which form a rigid three-dimensional network of colloidal silica in which pores may be filled with water (“aquagel”), in which water has been evaporated from pores (“xerogel”), or in which solvent has been removed from pores by supercritical extraction (“aerogel”). In various embodiments, colloidal silica gels of the present disclosure may be aquagels. As used herein, the term “substantial,” and grammatical variants thereof, specifically in regard to a colloidal silica, refers to an amount of gelling that produces a change of greater than 5 percent (5%) in any property (e.g., weight percent (wt. %), rheology, density, the like, or any combination thereof).

As used herein, the terms “activated,” “activated state,” or grammatical variations thereof, specifically in regard to colloidal silica, refer to a colloidal silica of the present disclosure in which a substantial gelling reaction has been initiated by contact between the inactivated colloidal silica and an alkaline activator, and/or by loss, removal, and/or inhibition of any gel retarding agents, and/or by addition of one or more accelerators capable of accelerating the gelling reaction, and/or by subjecting an inactivated colloidal silica and alkaline activator mixture to heat (e.g., at room temperature or above, e.g., at 100 °F or above, at formation temperature conditions (e.g., from about 120 °F to about 400 °F) or above).

Sealant compositions of the present disclosure may undergo various curing reactions. As used herein, the terms “cure,” “curing,” and grammatical variations therein, generally refer to reactions between activated colloidal silica gel, precursors thereof, or any combination thereof, and co-reactants (e.g., date palm seed particles) which result in polymerization and/or crosslinking of the sealant compositions. Curing of sealant compositions of the present disclosure may comprise a first transition from the flowable liquid-phase to a thickened-phase. As used herein, the term “thickening time,” and grammatical variants thereof, generally refers to the duration of time that sealant compositions remain in a fluid state capable of being pumped (i.e., flowable). With time, sealant compositions may undergo a second transition from the intermediate thickened-phase to a semi-solid phase (also referred to herein as a semi-solid state). As used in this disclosure, the term “semi-solid” refers to a state of the sealant compositions that is between a liquid material and a solid material in which the composition exhibits high elasticity and flexibility. In the semi-solid state, sealant compositions may be easily deformed but may return to shape upon releasing the deforming force.

With more time, cured sealant compositions may undergo a third transition into a solid phase (also referred to herein as a solid state). As used herein, the term “solid,” and grammatical variations thereof, generally refers to a state of the sealant compositions that is a rigid material in which the composition exhibits zero or negligible deformation. As used herein, the term “solidified sealant compositions,” and grammatical variants thereof, refer to any of the cured phases (either the elastic semi-solid or the rigid solid phases) that form after activation of sealant compositions of the present disclosure. As used herein, the terms “setting time,” “curing time,” and grammatical variations thereof, refer to the duration of time for sealant compositions to form solidified sealant compositions (e.g., either the semi-solid or the solid phases). A solidified sealant composition of the present disclosure (also referred to herein as a cured or a set sealant composition), whether an elastic semi-solid or a rigid solid, may be suitable for sealing an annulus of a wellbore, for sealing lost circulation zones within a subterranean formation, the like, or any combination thereof.

### Date Palm Seed Particles

In various embodiments, the date palm seed particles may be prepared from date palm (species Phoenix dactylifera) seeds. The chemical composition of date palm seeds may primarily be comprised of carbohydrates, crude cellulose/fiber, protein, fat, ash, and minerals (e.g., K, Na, Fe). Date palm seeds are considered as by-products of date fruit consumption and are generally discarded or used in animal feed. Utilizing date palm seeds in industrial applications is environmentally desirable in order to eliminate the need to dispose of such a large naturally available resource. Date palm seed particles may be added to sealant compositions of the present disclosure as a reinforcement material for date palm seed particle-silica composites to improve the mechanical properties.

In various embodiments, the date palm seeds may be obtained from genetically modified date palms (i.e., genetically modified organisms (GMOs)). In various embodiments, the date palm seeds may be Saudi Arabian date palm seeds. In various embodiments, the date palm seeds may be whole date palm seeds or fragments thereof. In various embodiments, the date palm seeds may be produced as a waste by-product from date processing, and the date palm seeds may be obtained from date processing plants to provide sustainable source of date palm seeds.

In various embodiments, the date palm seeds, or date palm seed particles thereof, may comprise untreated date palm seeds, or date palm seed particles thereof. As used in the disclosure, the term “untreated” or “without treating” refers to not treated with alkali or acid, not bleached, not chemically altered, not oxidized, and without any extraction or reaction process other than possibly drying of water. The term “untreated” or “without treatments” does not encompass grinding or heating to remove moisture but does encompass chemical or other processes that may change the characteristics or properties of the date palm seeds, or date palm seed particles thereof. In accordance with this definition, the date palm seeds, or date palm seed particles thereof, that are treated may behave in a manner different than the original starting material. In such embodiments, the date palm seed particles may be manufactured without treating before, during, or after washing, drying, crushing, grinding, or any other processing.

In various embodiments, the date palm seeds, or date palm seed particles thereof, may undergo one or more treatment processes before, during or after washing, drying, crushing, grinding, or any other processing. Suitable examples of treatment processes include, but are not limited to, the like, and any combination thereof. In various embodiments, date palm seed particles are prepared from date palm seeds by various pulverization methods. As used herein, the terms “pulverization,” “pulverizing,” and grammatical variations thereof, refer generally to reducing a material to very small particles. Suitable pulverizing methods include, but are not limited to, crushing, pressing, grinding, sieving, the like, and any combination thereof. In various embodiments, the date palm seeds may be washed and/or dried (e.g., air dried, oven dried, or the like) prior to pulverization. In various embodiments, the date palm seeds may be pulverized by grinding in a suitable grinder, e.g., an industrial grinder. In various embodiments, the date palm seeds may be crushed to a first size before being ground to a smaller second size. In various embodiments, the date palm seed particles may comprise, consist, or consist essentially of crushed date palm seeds, ground date palm seeds, or any combination thereof.

In various embodiments, the date palm seed particles may have various particle sizes, shapes, and/or distributions after pulverization. Date palm seed particles may comprise a mono-modal or multi-modal particle size (e.g., diameter) distribution. In various embodiments, the date palm seed particles may be segregated to produce date palm seed particles having a specific size or size distribution. In various embodiments, the date palm seed particles may be sifted using sieves having a sieve opening size that produces the desired particle size. Date palm seed particles may have an average particle size (e.g., diameter) range of from about 0.1 mm to about 5 mm, including all values and ranges therebetween (e.g., from about 0.1 mm to about 1.5 mm, from about 1.5 mm to about 3 mm, or from about 1 mm to about 1.5 mm), as determined by sieve granulometry. Depending on the size and/or size distribution, the date palm seed particles may seal gaps of various sizes when used to mitigate or prevent lost circulation in a well. In various embodiments, the date palm seed particles may be generally granular shaped with various size ranges to enable the date palm seed particles to enter porous and permeable paths, cracks, and fractures in a formation causing mud losses in order to produce an effective seal, barrier, or other preventative to further mud losses.

In various embodiments, the date palm seed particles may be present in the sealant compositions at from about 10 wt. % to about 60 wt. %, including all wt. % values and subsets therebetween, based on the total weight of the sealant compositions (e.g., from about 10 wt. % to about 50 wt. %, from about 10 wt. % to about 40 wt. %, from about 10 wt. % to about 30 wt. %, from about 10 wt. % to about 20 wt. %, from about 20 wt. % to about 60 wt. %, from about 20 wt. % to about 50 wt. %, from about 20 wt. % to about 40 wt. %, from about 20 wt. % to about 30 wt. %, from about 30 wt. % to about 60 wt. %, from about 30 wt. % to about 50 wt. %, from about 30 wt. % to about 40 wt. %, from about 40 wt. % to about 60 wt. %, from about 40 wt. % to about 50 wt. %, from about 50 wt. % to about 60 wt. %, about 10 wt. %, about 20 wt. %, about 25 wt. %, about 30 wt. %, about 40 wt. %, about 50 wt. %, or about 60 wt. %). In various embodiments, sealant compositions may include from about 30 wt. % to about 40 wt. % of the date palm seed particles.

### Activated Colloidal Silica Gel

In various embodiments, activated colloidal silica gels, or colloidal silica precursors thereof, of the present disclosure may comprise an aqueous dispersion of amorphous silica. In various embodiments, activated colloidal silica gels, or colloidal silica precursors thereof, may comprise various silica particle sizes. In various embodiments, the silica particles may comprise or are nanosilica particles.

In various embodiments, the activated colloidal silica gels, or colloidal silica precursors thereof, may comprise various quantities of silica particles. In various embodiments, the activated colloidal silica gels, or colloidal silica precursors thereof, may comprise from about 20 wt. % to about 60 wt. % silica actives, including all wt. % values and subsets therebetween, by total weight of the colloidal silicas (e.g., from about 20 wt. % to about 50 wt. %, from about 20 wt. % to about 40 wt. %, from about 20 wt. % to about 30 wt. %, from about 30 wt. % to about 60 wt. %, from about 30 wt. % to about 50 wt. %, from about 30 wt. % to about 40 wt. %, from about 40 wt. % to about 60 wt. %, from about 40 wt. % to about 50 wt. %, from about 50 wt. % to about 60 wt. %, about 20 wt. %, about 30 wt. %, about 40 wt. %, about 50 wt. %, or about 60 wt. %).

In various embodiments, alkaline activators of the present disclosure may be selected from the group consisting of an alkali metal salt, an alkaline earth metal salt, the like, and any combination thereof. In various embodiments, alkaline activators are selected from the group consisting of a silicate salt, a hydroxide salt, a carbonate salt, a sulfate salt, an oxide, the like, and any combination thereof. In various embodiments, alkaline activators may be selected from the group consisting of alkali metal silicates, alkaline earth metal silicates, alkali metal hydroxides, alkaline earth metal hydroxides, alkali metal carbonates, alkaline earth metal carbonates, alkali metal sulfates, alkaline earth metal sulfates, alkali metal oxides, alkaline earth metal oxides, the like, and any combination thereof. Examples of suitable alkaline activators may include, but are not limited to, sodium hydroxide, sodium silicate, potassium silicate, potassium hydroxide, sodium carbonate, sodium sulfate, lime, slaked lime, the like, and any combination thereof.

In various embodiments, alkaline activators may be comprised in an aqueous solution. In various embodiments, alkaline activators may comprise from about 10 wt. % to about 50 wt. % of active alkaline activator, including all wt. % values and subsets therebetween (e.g., from about 20 wt. % to about 50 wt. %, from about 20 wt. % to about 40 wt. %, from about 20 wt. % to about 30 wt. %, from about 30 wt. % to about 50 wt. %, from about 30 wt. % to about 40 wt. %, from about 40 wt. % to about 50 wt. %, about 10 wt. %, about 20 wt. %, about 30 wt. %, about 40 wt. %, or about 50 wt. %). In various embodiments, alkaline activator aqueous solutions may have a pH of from about 10 to about 13, including all pH values and subsets therebetween (e.g., from about 10 to about 12, from about 10 to about 11, from about 11 to about 13, from about 11 to about 12, or from about 12 to about 13).

In various embodiments, precursors of activated colloidal silica gels may comprise a weight ratio of alkaline activator actives to silica actives of from about 0.1 to about 0.5, including all actives weight ratio values and subsets therebetween (e.g., from about 0.2 to about 0.5, from about 0.2 to about 0.4, from about 0.2 to about 0.3, from about 0.3 to about 0.5, from about 0.3 to about 0.4, from about 0.4 to about 0.5, about 0.1, about 0.2, about 0.3, about 0.4, or about 0.5).

In various embodiments, the activated colloidal silica gel, precursors thereof, or any combination thereof, may be present in the sealant compositions at from about 40 wt. % to about 90 wt. %, including all wt. % values and subsets therebetween, based on the total weight of the sealant compositions (e.g., from about 40 wt. % to about 80 wt. %, from about 40 wt. % to about 70 wt. %, from about 40 wt. % to about 60 wt. %, from about 40 wt. % to about 50 wt. %, from about 50 wt. % to about 90 wt. %, from about 50 wt. % to about 80 wt. %, from about 50 wt. % to about 70 wt. %, from about 50 wt. % to about 60 wt. %, from about 60 wt. % to about 90 wt. %, from about 60 wt. % to about 80 wt. %, from about 60 wt. % to about 70 wt. %, from about 65 wt. % to about 70 wt. %, from about 70 wt. % to about 90 wt. %, from about 70 wt. % to about 80 wt. %, from about 80 wt. % to about 90 wt. %, about 40 wt. %, about 50 wt. %, about 60 wt. %, about 65 wt. %, about 70 wt. %, about 80 wt. %, or about 90 wt. %).

### Set Retarding Agents

In various embodiments, the sealant compositions may further comprise a set retarding agent. As used herein, the term “set retarding agent,” and grammatical variants thereof, refers to a substance that prevents, delays, and/or slows undesired setting and hardening of the sealant compositions of the present disclosure. The thickening and solidification time of the sealant compositions of the present disclosure may be designed to be sufficiently long to enable performance of drilling operations, e.g., where the sealant compositions remain in a flowable state until drilling of a wellbore is complete.

The thickening and solidification time of the sealant compositions may further be influenced or otherwise delayed with one or more set retarding agents disclosed herein. Suitable set retarding agents may include, but are not limited to, lignosulfonate, sodium borate, zinc borate, boric acid, sodium tartrate, sodium citrate, sodium gluconate, sodium itaconate, tartaric acid, citric acid, gluconic acid, itaconic acid, and the like, and any combination thereof.

### Other Polymerization Reactions

In addition to the curing reaction of activated colloidal silica gels with the other components of the sealant compositions disclosed herein, sealant compositions of the present disclosure may be susceptible to various other curing or polymerization reactions, e.g., reactions of the sealant compositions of the present disclosure with materials or compounds present in a subterranean formation into which the sealant compositions are introduced or as part of a subterranean operation fluid comprising the sealant compositions, such reactions including, but not limited to, pozzolanic reactions, geopolymerization reactions, the like, and any combination thereof. As used herein, the term “pozzolanic reaction,” and grammatical variations thereof, refers to the polymerization reaction of finely ground siliceous and aluminous materials with calcium hydroxide in the presence of water at room temperatures or with heat to form calcium silicates hydrates (CSH) and calcium aluminates hydrates (CAH), to form cements. As used herein, the term “geopolymerization,” and grammatical variants thereof, refers to the polymerization of an aluminosilicate material by an alkaline activator in the presence of heat, thus forming a geopolymer. As used herein, the term “geopolymer,” and grammatical variants thereof, refers to a solid, three-dimensional tetrahedral silicon oxide network in which aluminum is substituted for silicon in at least a portion of the tetrahedral positions. In one embodiment, a geopolymer comprises linkages selected from: Si—S; Si—O; Al—O; Si—O—Si; Al—O—Al; Si—O—Al; Si—O—Al—O; Si—O—Al—O—Si—O; Si—O—Al—O—Si—O—Si—O; and any combination thereof. In one embodiment, a set retarding agent of the present disclosure may prevent, delay, and/or slow various other reactions, e.g., pozzolanic reactions, geopolymerization reactions, the like, or any combination thereof, of said precursors and/or of activated colloidal silica gels of the present disclosure, thus allowing control of formation of the solidified sealant compositions described herein.

### Properties of Sealant Compositions

Flowable sealant compositions of the present disclosure may be pumpable and suitable for use as a subterranean formation operation fluid, e.g., a drilling fluid, a cementing slurry, the like, or any combination thereof. For example, in various embodiments, the sealant composition may be adapted to different downhole conditions by changing the concentrations of the activated colloidal silica gel, precursors thereof, or any combination thereof, accelerators, or cure retarding agents in the sealant composition to modify the specific gravity, rheology, fluid loss, mechanical properties, thickening and/or curing time, gas and fluid migration, or other properties of the sealant compositions.

The rheology and density of flowable sealant compositions may be adjusted over a wide range of values depending on the requirement for the well and the downhole conditions of the well. The sealant composition may have a density that enables the sealant composition to exert hydrostatic pressure on the wellbore wall or interior surface of an outer casing to support the wellbore, prevent fluids from flowing from the subterranean formation into the wellbore, or both.

The flowability of sealant compositions may be determined by measuring the rheological properties of sealant compositions. Various rheological properties of sealant compositions may be determined, including viscosity (“V”), plastic viscosity (“PV”), yield point (“YP”), low shear yield point (“LSYP”), and the like.

As used herein, the term “viscosity,” and grammatical variations thereof, refers generally to the ratio of shear stress to shear rate. Viscosity is expressed in centipoise (cP) and may be calculated by measuring the viscosity of sealant compositions using a rheometer at a spindle speed of three hundred rotations per minute (rpm).

As used herein, the terms “plastic viscosity” or “PV,” and grammatical variants thereof, refer to a rheology property related to the resistance of a fluid (i.e., the flowable sealant compositions of the present disclosure) to flow due to mechanical interaction between solids therein. The PV is expressed in centipoise (cP) and may be calculated by measuring the shear stress of sealant compositions using a rheometer at spindle speeds of 300 rpm and 600 rpm and subtracting the 300 rpm dial reading from the 600 rpm dial reading according to the Equation (I): PV=(Dial Reading at 600 rpm)−(Dial Reading at 300 rpm).

As used herein, the terms “yield point” or “YP,” and grammatical variants thereof, refer to a rheology property related to the value obtained from the Bingham-Plastic rheological model when extrapolated to a shear rate of zero. The YP is expressed as force per area, such as foot-pounds per 100 square feet (lbf/100 ft²) and may be calculated using 300 rpm and 600 rpm shear rate readings and the PV value (expressed in Equation (I)) according to the Equation (II): YP=(Dial Reading at 300 rpm)−PV.

As used herein, the terms “low shear yield point” or “LSYP,” and grammatical variants thereof, refer to a rheology property related to an estimate of the yield stress at the lowest shear stress value above which a material will behave like a fluid and below which the material will behave like a solid. LSYP is expressed as force per area, such as lbf/100 ft², and may be calculated by measuring the shear stress of the sealant compositions using a rheometer at spindle speeds of 3 rotations per minute (rpm) and 6 rpm according to Equation (III): LSYP=[2*(Dial Reading at 3 rpm)]−(Dial Reading at 6 rpm)].

Upon activation, sealant compositions of the present disclosure may be usable for a sufficient time, e.g., suitable for pumping, use during drilling operations in a wellbore in a subterranean formation, and the like. As used herein, the term “thickening time,” and grammatical variants thereof, refers to the duration of time that sealant compositions remain in a fluid state capable of being pumped or used in a particular subterranean operation (i.e., flowable). In various embodiments, a non-pumpable viscosity is specified as a particular Bearden consistency (e.g., 70 Bearden consistency units (70 Bc), 90 Bc, or 100 Bc) at a target temperature, e.g. 200 °F. In certain embodiments, the thickening time of an activated flowable sealant composition of the present disclosure is measured according to API Specification 10A, ANSI/API 10A, ISO 10426-1-2001, or API RP 10B-2.

As used herein, the term “solidification time” refers to the duration of time that sealant compositions require to transition to the solidified phase (e.g., either the semi-solid or the solid phase). The thickening and solidification time of sealant compositions of the present disclosure may be influenced or otherwise delayed by adjusting the concentration of the colloidal silica and/or the alkaline activator and/or a cure retarding agent.

### Solidified Sealant Compositions

Solidified sealant compositions of the present disclosure may be capable of withstanding a wide range of temperatures and pressures without failing or deteriorating. Failure or deterioration of the solidified sealant compositions may allow liquids or gases to penetrate into or through the solidified sealant compositions. For example, the sealant composition, once solidified, may be capable of withstanding temperatures of from 20 degrees Celsius (°C) to 205 °C. The solidified sealant compositions may also be able to withstand temperature cycling within said temperature range. Solidified sealant composition of the present disclosure may also be capable of withstanding pressures of up to four million pounds of force per square inch (psi) (1 psi equals 6.89476 kilopascals (kPa)). For example, in various embodiments, the solidified sealant composition may be capable of withstanding pressures of from 14 psi to 4 million psi without failing or deteriorating to allow liquids or gases to penetrate into or through the sealant composition.

### Subterranean Operation Drilling Fluids

In an aspect, the present disclosure provides a subterranean operation fluid including a sealant composition of the present disclosure, or one or more components thereof. In various embodiments, a subterranean operation fluid may be selected from the group consisting of an aqueous-based drilling fluid, an oil-based drilling fluid, a drilling pill, a cementing fluid, and any combination thereof. In various embodiments, a subterranean operation fluid may be a drilling fluid comprising a base fluid and a sealant composition of the present disclosure. In various embodiments, the subterranean operation fluid of the present disclosure may have suitable properties, such as suitable rheology (e.g., pumpability, delayed thickening time, or the like), suitable for use in a subterranean operation of the present disclosure.

### Methods Related to Sealant Compositions

In an aspect, the present disclosure provides methods of making sealant compositions and/or using sealant compositions in subterranean operations (e.g., drilling operations, cementing operations, enhanced recovery operations, or other subterranean operations), e.g., to mitigate a flow of a fluid into a subterranean formation via a lost circulation zone and/or to cement a casing in a wellbore. In various embodiments, methods may comprise: introducing a sealant composition into a wellbore where the sealant composition comprises: date palm seed particles and an activated colloidal silica gel, precursors thereof, or any combination thereof; heating the sealant compositions; and allowing the sealant composition to set to form a solidified sealant composition. In various embodiments, the solidified sealant composition may be formed within a zone of interest (e.g., a lost circulation zone) during a drilling operation and/or within an annulus between the wellbore and a casing during a cementing operation. In various embodiments, forming a solidified sealant composition may mitigate a flow of a fluid, e.g., forming a solidified sealant composition within a zone of interest may mitigate a flow of a fluid from the wellbore into the subterranean formation. In various embodiments, methods may use any sealant compositions of the present disclosure.

### Lost Circulation Operations

As used herein, the term “zone of interest,” and grammatical variants thereof, refers to a location within a wellbore, e.g., a depleted zone, a zone of low pressure, a lost circulation zone, a fracture zone, or any combination thereof. In various embodiments, methods may comprise any subterranean operation of the present disclosure (e.g., a drilling operation, a cementing operation, an enhanced production operation, or any other subterranean operation) performed within a zone of interest. In various embodiments, subterranean operations (e.g., drilling operations or other subterranean operations) may use any subterranean operation fluid of the present disclosure (e.g., a drilling fluid, a cementing fluid, a fracturing fluid, or any other subterranean operation fluid) in a zone of interest. In various embodiments, the subterranean operation fluid may comprise an aqueous-based drilling fluid, an oil-based drilling fluid, a drilling pill, a cementing fluid, the like, or any combination thereof. In various embodiments, subterranean operation fluids of the present disclosure may comprise a base fluid, sealant compositions of the present disclosure, and optionally one or more other components.

In various embodiments, sealant compositions may be lost circulation material (LCM) compositions. In various embodiments, methods may comprise introducing an LCM composition into a zone of interest within a subterranean formation via the wellbore and allowing the LCM composition to cure therein. In various embodiments, methods may comprise using the LCM composition to control fluid loss from the wellbore into the subterranean formation during any subterranean operation of the present disclosure.

In various embodiments, subterranean operations may comprise a drilling operation and use a drilling fluid of the present disclosure. During typical drilling operations, a drilling fluid of the present disclosure is continuously pumped into a wellbore penetrating a subterranean formation to lubricate the drill bit and also to clear and clean the wellbore and the filings (also referred to as “cuttings”) resulting from drilling. The drilling fluid is then typically pumped from a mud pit into the wellbore and returns again to the surface. An indication that a depleted zone, zone of low pressure, lost circulation zone, or fractured zone has been encountered is when the flow rate of the drilling fluid that returns to the surface is less than the flow rate of the drilling fluid pumped into the wellbore. This reduction or absence of returning drilling fluid is referred to as lost circulation in the context of a drilling operation.

Drilling fluids comprising the sealant compositions of the present disclosure may be used for drilling all or portions of a wellbore. For example, the sealant compositions of the present disclosure may be added to the drilling fluid when a depleted zone, a zone of low pressure, a lost circulation zone, or a fractured zone is encountered. Fractured zones may include fractures that are natural or induced, vugular or cavernous, highly permeable, or unconsolidated. Alternatively, the sealant compositions of the present disclosure may be included in the drilling fluid regardless of encountering a depleted zone, a zone of low pressure, a lost circulation zone, or a fractured zone.

A drilling fluid, when introduced into the wellbore, will enter a zone of interest, wherein the zone of interest, for example, may be a depleted zone, a zone of low pressure, a lost circulation zone, a fracture zone, or any combination thereof. The activated colloidal silica gel, precursors thereof, or any combination thereof, present within sealant compositions of the present disclosure may initiate and/or accelerate setting and hardening (e.g., curing or polymerization) of the sealant compositions in the presence of heat to form solidified sealant compositions of the present disclosure. Heat may be applied to the zone of interest solely due to natural downhole temperatures, thereby increasing the temperature of the sealant compositions and causing the sealant compositions to form the solidified sealant compositions in the zone of interest. Heat may additionally be applied to the zone of interest from an external heat source such as a downhole heater (e.g., an immersion heater or a circulation heater).

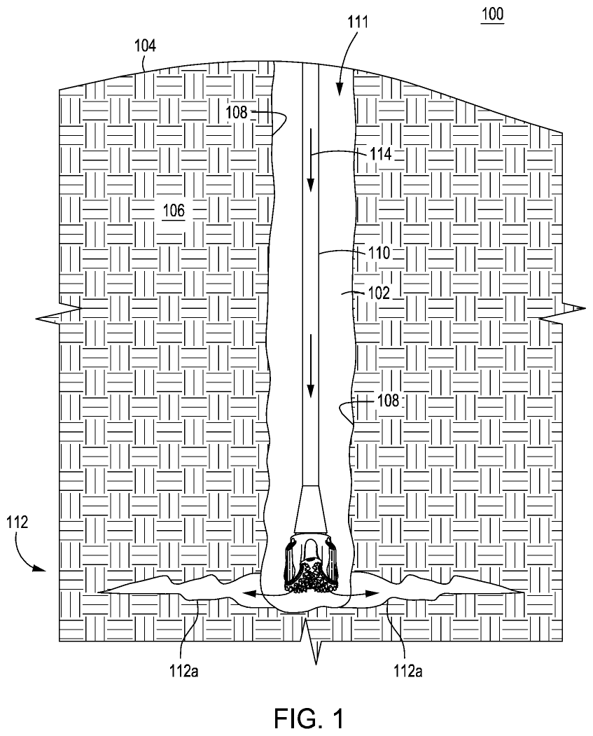

FIG. 1 illustrates a non-limiting example of a well site 100 having a wellbore 102 through the Earth's surface 104 into a subterranean formation 106 in the Earth's crust. To form the wellbore 102, a hole (i.e., a borehole) is drilled into the subterranean formation 106 to generate a drilled formation surface 108 as an interface for the wellbore 102 with the subterranean formation 106. The formation surface 108 may be characterized as the wellbore 102 wall. FIG. 1 illustrates the elements of such a drilling operation. The wellbore 102 may have open hole portions but generally includes a drill string 110. In this nonlimiting example, the wellbore 102 has a lost circulation zone 112 in the subterranean formation 106 at that portion of the wellbore 102. The lost circulation zone 112 causes or contributes to the lost circulation of a fluid 114 (i.e., in this case, a drilling fluid) into the subterranean formation 106. The lost circulation zone 112 has structural features or characteristics which may include, but are not limited to, fractures, voids, vugulars (i.e., vugs), gaps, permeable channels, cavities, cavernous openings, the like, and any combination thereof.

The fluid 114 is introduced from the Earth's surface 104 by flowing downward through the drill string 110 and is discharged from the drill bit as drilling proceeds, and then flows upward through the annulus between the subterranean formation 106 and the drill string 110 toward the Earth's surface 104 as a return fluid. Some or all of the fluid 114 flowing upward through the annulus may be lost through the lost circulation zone 112 into the subterranean formation 106.

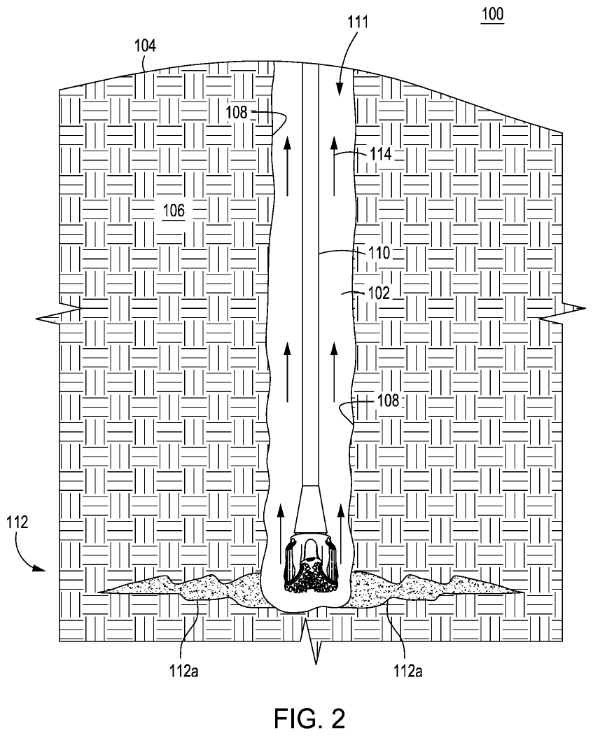

FIG. 2 illustrates a non-limiting example of the same well site 100 as described for FIG. 1, except that sealant compositions of the present application are utilized to treat the lost circulation zone 112 to mitigate (e.g., prevent or reduce) the flow of fluid 114 from the wellbore 102 into the subterranean formation 106. In such cases, sealant compositions of the present application may be added directly to the fluid 114 to be introduced (e.g., pumped) into wellbore 102.

The sealant compositions may be similarly introduced into the zone of interest in the form of a treatment pill. In such cases, the drilling fluid may be replaced by the treatment pill until the lost circulation is reduced. This may be useful as drilling fluids are costly and specifically designed for drilling, whereas the treatment pill is designed to stop the lost circulation before drilling is continued. In such cases, the treatment pill containing the sealant composition may be injected into the wellbore specifically as a lost circulation curing procedure (also referred to herein as “wellbore strengthening,” or “wellbore remediation”). In general, a treatment pill may be a relatively small quantity or volume of a carrier fluid as a specialized blend with sealant compositions utilized for a particular purpose in treating the wellbore 102 or subterranean formation 106.

Once the sealant compositions enter the lost circulation zone 112, the sealant compositions may be heated to accelerate setting (e.g., curing or polymerization) of the sealant compositions. For example, the sealant compositions may be allowed to heat due to the surrounding formation temperature conditions as disclosed herein.

In various embodiments, mitigating the flow of liquid from the wellbore may correspond to mitigating the flow of a negligible volume of, or all of the volume of the liquid from the wellbore. Mitigation of the flow of fluids may be referred to herein as a “fluidic seal,” in which a barrier is formed to the flow of fluids (e.g., drilling fluids or other fluid types). A fluidic seal may form a barrier having a permeability of less than about 0.1 darcies, including complete sealing such that no fluid passes through the fluidic seal.

Optionally, the sealant compositions may include a component (or additive), as described herein for the breakdown and removal of at least a portion of the fluidic seal. As used herein, the term “at least a portion,” with reference to the breakdown and removal of the fluidic seal, and grammatical variants thereof, refers to restoring the zone of interest (e.g., lost circulation features of 114 of FIG. 1) in which the fluidic seal was formed to a permeability no less than about 75% of the original permeability of the target zone.

In various embodiments, methods may further include one or more preparation steps for one or more components of the sealant compositions prior to introducing the sealant compositions to the zone of interest. In various embodiments, preparation steps may include blending at least a portion of the epoxy resin with at least one diluent. In various embodiments, preparation steps may include blending at least a portion of the epoxy resin with at least a portion of the curing agent. In various embodiments, preparation steps may include blending and/or impregnating at least a portion of the red mud with at least a portion of each of the other components of the sealant composition.

In various embodiments, introducing the sealant compositions to the zone of interest may include forming the sealant composition prior to introducing the sealant composition to the zone of interest. In various embodiments, introducing the sealant compositions to the zone of interest may include separately introducing at least one component of the sealant compositions to the zone of interest prior to, concurrently with, or after any other components of the sealant compositions, such that the entire sealant composition is not formed prior to introduction of each of the components to the wellbore and/or to the zone of interest. In various embodiments, introducing the sealant compositions to the zone of interest may include introducing at least one subterranean operation fluid selected from the group consisting of an aqueous-based drilling fluid, an oil-based drilling fluid, a drilling pill, a cementing fluid, and any combination thereof, to the zone of interest, where each component of the sealant compositions is comprised in at least one of the subterranean operation fluids. In various embodiments, a single subterranean operation fluid may comprise all components of a sealant composition, which may be prepared prior to or during preparation of the subterranean operation fluid. In various embodiments, at least one component of the sealant compositions may be separately included in a different subterranean operation fluid from any of the other components, such that the sealant composition is not formed prior to introduction of each of the different subterranean operation fluids to the wellbore and/or the zone of interest.

### Cementing Operations

In various embodiments, a sealant composition of the present disclosure may be a cementing composition. For a cementing operation, the drill string 110 of FIGS. 1 and 2 may be replaced with a casing string 110 (also referred to herein as casing), through which a fluid 114 (i.e., in this case, a cementing fluid or cementing slurry) is introduced from the Earth's surface 104 (i.e., by flowing downward through the casing string 110), is discharged at the bottom of the wellbore 102, and flows upward through the annulus between the subterranean formation 106 and the casing or casing string 110 toward the surface 104, and is allowed to cure into a cement sheath therein. Some or all of the cementing fluid or cementing slurry 114 flowing upward through the annulus may be lost into the subterranean formation 106 through the lost circulation zone 112. The sealant compositions of the present application may be utilized to form a cement sheath within the annulus, to treat the lost circulation zone 112 to mitigate (e.g., prevent or reduce) a flow of fluids from the wellbore into the subterranean formation (as shown in FIG. 2), or any combination thereof. A cementing fluid or cementing slurry 114 comprising the sealant compositions of the present application may be introduced (e.g., pumped) into the wellbore 102, e.g., in a same or different manner than described above for drilling operations.

Other technical features may be readily apparent to one skilled in the art from the following figures, descriptions, and claims.

Embodiments disclosed herein include:

Embodiment A: A method comprising: introducing a sealant composition into a wellbore within a subterranean formation; wherein the sealant composition comprises: date palm seed particles; and an activated colloidal silica gel, a colloidal silica and an alkaline activator, or any combination thereof; heating the sealant composition; and allowing the sealant composition to cure to form a solidified sealant composition.

Embodiment B: Sealant compositions comprising: date palm seed particles; and an activated colloidal silica gel, a colloidal silica and an alkaline activator, or any combination thereof; wherein the sealant composition is capable of curing upon heating to form a solidified sealant composition.

Each of embodiments A and B may have one or more of the following additional elements in any combination:

Element 1: wherein the sealant composition is a lost circulation material (LCM) composition; wherein the sealant composition is introduced into a zone of interest within the subterranean formation via the wellbore; wherein the zone of interest is selected from the group consisting of a depleted zone, a zone of low pressure, a lost circulation zone, a fracture zone, and any combination thereof; and wherein the sealant composition is cured to form the solidified sealant composition within the zone of interest.

Element 2: wherein the solidified sealant composition formed in the zone of interest mitigates a flow of fluids from the wellbore into the subterranean formation.

Element 3: wherein the sealant composition is a cementing composition; wherein the sealant composition is introduced into an annulus between the wall of the wellbore and a casing disposed therein; and wherein the sealant composition is cured to form the solidified sealant composition within the annulus.

Element 4: wherein heating the sealant composition occurs upon contact of the sealant composition with the subterranean formation.

Element 5: wherein the colloidal silica comprises a colloidal nanosilica.

Element 6: wherein the alkaline activator is selected from the group consisting of alkali metal silicates, alkaline earth metal silicates, alkali metal hydroxides, alkaline earth metal hydroxides, alkali metal carbonates, alkaline earth metal carbonates, alkali metal sulfates, alkaline earth metal sulfates, alkali metal oxides, alkaline earth metal oxides, and any combination thereof.

Element 7: wherein the sealant composition further comprises a set retarding agent.

Element 8: wherein the sealant composition has a curing time, at a temperature of 200 °F, of at least 50 minutes (min).

Element 9: wherein the solidified sealant composition mitigates a flow of fluid at a pressure of 1500 psi and at a temperature of about 200 °F, for at least 40 minutes.

Element 10: wherein, prior to introducing the sealant composition into the wellbore, the method further comprises: pulverizing date palm seeds to form the date palm seed particles; segregating the date palm seed particles by size; blending at least a portion of each of the colloidal silica and the alkaline activator with one another; and/or blending and/or impregnating at least a portion of the date palm seed particles with at least a portion of each of the other components of the sealant compositions.

Element 11: wherein introducing the sealant composition into the wellbore comprises introducing at least one subterranean operation fluid into the wellbore; wherein the at least one subterranean operation fluid is selected from the group consisting of a drilling fluid, a drilling pill, a cementing slurry, and any combination thereof; wherein the at least one sealant composition, taken together, comprise each of the components of the sealant composition; and wherein each component of the sealant composition is comprised in the same subterranean operation fluid, or wherein at least two components of the sealant composition are comprised in at least two different subterranean operation fluids.

By way of non-limiting example, exemplary combinations applicable to A and B include any one, more, or all of Elements 1-11 in any combination.

The present disclosure is further directed to the following non-limiting embodiments.

Embodiment 1: A method comprising: introducing a sealant composition into a wellbore within a subterranean formation; wherein the sealant composition comprises: date palm seed particles; and an activated colloidal silica gel, a colloidal silica and an alkaline activator, or any combination thereof; heating the sealant composition; and allowing the sealant composition to cure to form a solidified sealant composition.

Embodiment 2: The method of Embodiment 1, wherein the sealant composition is a lost circulation material (LCM) composition; wherein the sealant composition is introduced into a zone of interest within the subterranean formation via the wellbore; wherein the zone of interest is selected from the group consisting of a depleted zone, a zone of low pressure, a lost circulation zone, a fracture zone, and any combination thereof; and wherein the sealant composition is cured to form the solidified sealant composition within the zone of interest.

Embodiment 3: The method of Embodiment 2, wherein the solidified sealant composition formed in the zone of interest mitigates a flow of a fluid from the wellbore into the subterranean formation.

Embodiment 4: The method of any one of Embodiments 1-3, wherein the sealant composition is a cementing composition; wherein the sealant composition is introduced into an annulus between the wall of the wellbore and a casing disposed therein; and wherein the sealant composition is cured within the annulus.

Embodiment 5: The method of any one of Embodiments 1-4, wherein heating the sealant composition occurs upon contact of the sealant composition with the subterranean formation.

Embodiment 6: The method of any one of Embodiments 1-5, wherein the colloidal silica comprises a colloidal nanosilica.

Embodiment 7: The method of any one of Embodiments 1-6, wherein the alkaline activator is selected from the group consisting of alkali metal silicates, alkaline earth metal silicates, alkali metal hydroxides, alkaline earth metal hydroxides, alkali metal carbonates, alkaline earth metal carbonates, alkali metal sulfates, alkaline earth metal sulfates, alkali metal oxides, alkaline earth metal oxides, and any combination thereof.

Embodiment 8: The method of any one of Embodiments 1-7, wherein the sealant composition further comprises a set retarding agent.

Embodiment 9: The method of any one of Embodiments 1-8, wherein the sealant composition has a curing time, at a temperature of 200 °F, of at least 50 minutes (min).

Embodiment 10: The method of any one of Embodiments 1-9, wherein the solidified sealant composition mitigates a flow of a fluid through the solidified sealant composition at a pressure of 1500 psi and at a temperature of about 200 °F, for at least 40 minutes.

Embodiment 11: The method of any one of Embodiments 1-10, wherein, prior to introducing the sealant composition into the wellbore, the method further comprises: pulverizing date palm seeds to form the date palm seed particles; segregating the date palm seed particles by size; blending at least a portion of each of the colloidal silica and the alkaline activator with one another; and/or blending and/or impregnating at least a portion of the date palm seed particles with at least a portion of each of the other components of the sealant compositions.

Embodiment 12: The method of any one of Embodiments 1-11, wherein introducing the sealant composition into the wellbore comprises introducing at least one subterranean operation fluid into the wellbore; wherein the at least one subterranean operation fluid is selected from the group consisting of a drilling fluid, a drilling pill, a cementing slurry, and any combination thereof; wherein the at least one sealant composition, taken together, comprise each of the components of the sealant composition; and wherein each component of the sealant composition is comprised in the same subterranean operation fluid, or wherein at least two components of the sealant composition are comprised in at least two different subterranean operation fluids.

Embodiment 13: A sealant composition, comprising: date palm seed particles; and an activated colloidal silica gel, a colloidal silica and an alkaline activator, or any combination thereof; wherein the sealant composition is capable of curing upon heating to form a solidified sealant composition.

Embodiment 14: The sealant composition of Embodiment 13, wherein the colloidal silica comprises a colloidal nanosilica.

Embodiment 15: The sealant composition of Embodiment 13 or Embodiment 14, wherein the alkaline activator is selected from the group consisting of alkali metal silicates, alkaline earth metal silicates, alkali metal hydroxides, alkaline earth metal hydroxides, alkali metal carbonates, alkaline earth metal carbonates, alkali metal sulfates, alkaline earth metal sulfates, alkali metal oxides, alkaline earth metal oxides, and any combination thereof.

Embodiment 16: The sealant composition of any one of Embodiments 13-15, wherein the sealant composition further comprises a set retarding agent.

Embodiment 17: The sealant composition of any one of Embodiments 13-16, wherein the sealant composition has a curing time, at a temperature of 200 °F, of at least 50 minutes (min).

Embodiment 18: The sealant composition of any one of Embodiments 13-17, wherein the solidified sealant composition mitigates a flow of a fluid through the solidified sealant composition at a pressure of 1500 psi and at a temperature of about 200 °F, for at least 40 minutes.

To facilitate a better understanding of the aspects of the present disclosure, the following examples of preferred or representative aspects are given. In no way should the following examples be read to limit, or to define, the scope of the disclosure.

### EXAMPLE

This example discloses an in-situ method of using date palm seed particle-nanosilica composites as rigid sealant compositions. The novelty and advantage of this invention is combining date palm seed particles and activated colloidal nanosilica gel to form a date palm seed particle-nanosilica composite. The date palm seed particle-nanosilica composite was prepared from the abundant source of date palm seeds in Saudi Arabia that makes this invention cost-effective.

FIG. 1 shows a schematic illustration of a wellbore within a subterranean formation where, during a drilling operation, loss of drilling fluid within the wellbore may possibly occur into the subterranean formation via a lost circulation zone. FIG. 2 shows a schematic illustration of a subterranean formation in which a date palm seed-silica composite of the present disclosure is formed within a lost circulation zone for use as a lost circulation material to prevent loss of drilling fluid into the subterranean formation.

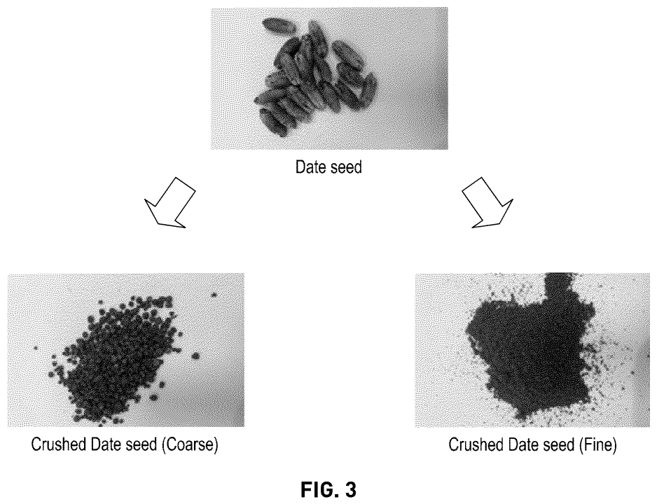

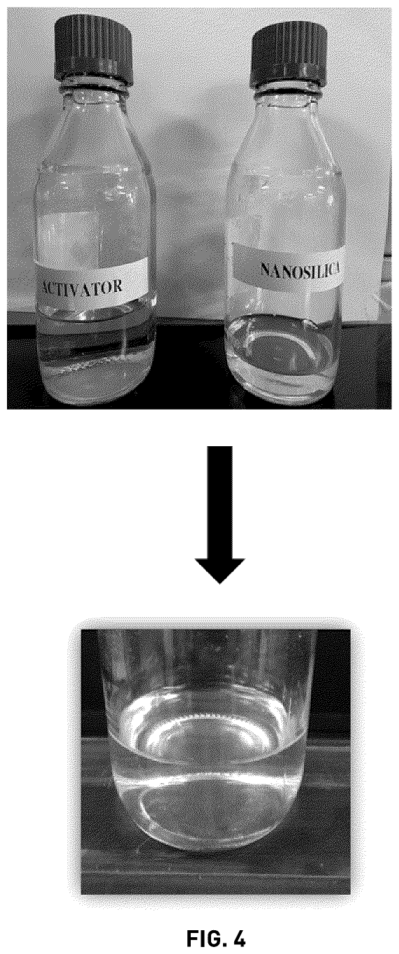

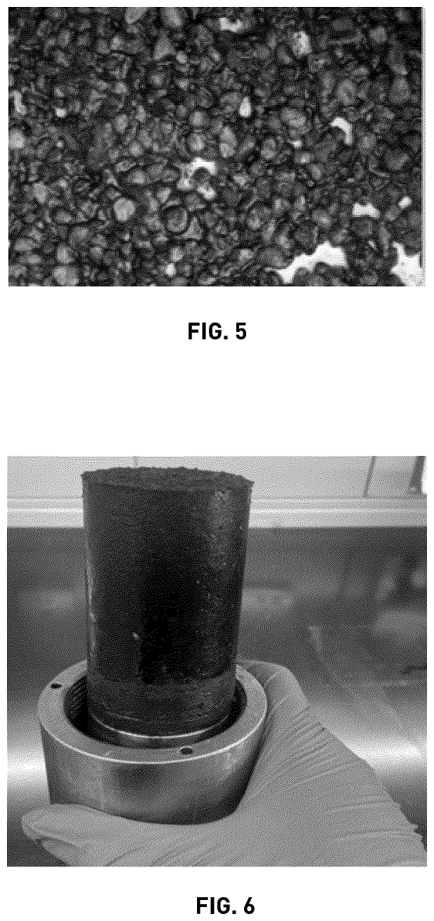

FIGS. 3-5 illustrate the primary components used to form the disclosed date palm seed-silica composite. The main components of the proposed innovation are: date palm seed particles and activated colloidal silica gel. Preparation of primary components of the disclosed date palm seed-silica composite for lost circulation material may comprise the following steps. The dry date palm seeds may be crushed and sorted by fracture size as shown in FIG. 3 (showing date palm seeds before and after crushing and sieving). The activated colloidal silica gel may be prepared upon reaction of two components: colloidal silica (e.g., colloidal nanosilica) and an alkaline activator (e.g., sodium silicate), as shown in FIG. 4. Generally, colloidal nanosilica is 40% active nanosilica dispersed in water, and the alkaline activator is an aqueous solution comprising 30 wt. %-40 wt. % active alkaline activator. After preparing crushed date palm seeds, the activated colloidal silica gel (e.g., the activated colloidal nanosilica gel) solution may be added to crushed date palm seeds which may be held under vacuum (e.g., for about 3 minutes) to ensure full absorption of activated colloidal silica gel as shown in FIG. 5.

A date palm seed-silica composite prepared by curing the sealant composition for one hour in a cell of a standard high temperature/high pressure (“HT/HP”) filter press (500 ml) conforming to American Petroleum Institute (“API”) specifications and equipped with pressure and temperature gages (“HT/HP API filter press”). A drilling mud solution was added on top of the date palm seed-silica composite to evaluate the performance in plugging efficiency of the date palm seed-silica composite using a leak-off test using the HT/HP API filter press with a 3 millimeter (“mm”) fracture filter disc. Zero leak-off of effluent from the drilling mud was observed when 1500 pounds per square inch (“psi”) pressure was applied to the HT/HP API filter press at 200 °F for almost 45 minutes, which is an indication of total plugging by the date palm seed-silica composite. FIG. 6 shows the date palm seed-silica composite which was pushed out of the cylinder in one piece without any breakage after the leak-off test, indicating that the date palm seed-silica composite is a rigid material. In comparison, when crushed date palm seed particles with mud alone were evaluated, without using colloidal nanosilica, there was a slight leak-off of the effluent. This indicates that the addition of crushed date palm seed particles and activated colloidal nanosilica gel as sealant compositions improved the plugging efficiency of the mud by forming the new rigid date palm seed-silica composite.

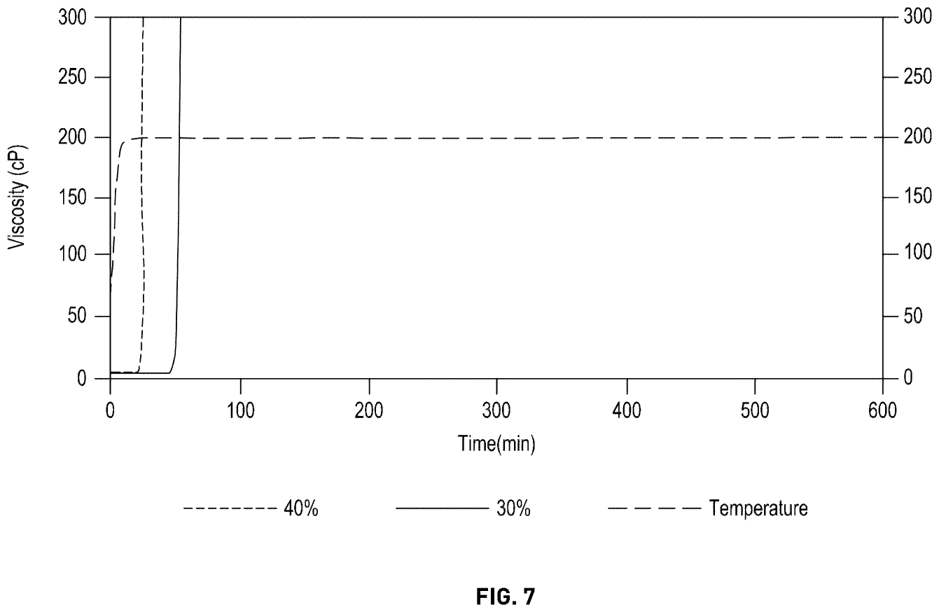

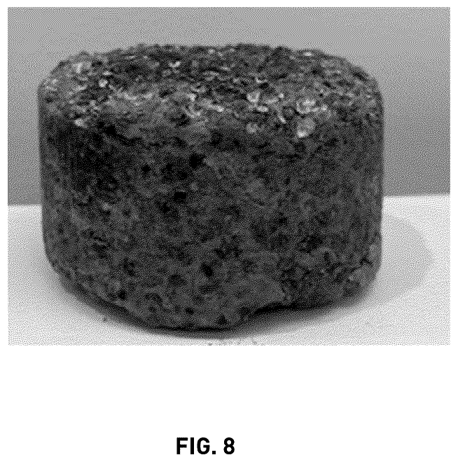

After preparation, the crushed date palm seed particles and activated colloidal silica gel mixture may be cured/solidified at any given temperature such as reservoir temperature to form a rigid material suitable as sealant compositions. The curing time must be controlled to have a sufficient time to pump the sealant compositions to avoid any curing within the drill pipe, so that the sealant compositions are delivered into the targeted zone. The gelation or curing time may be adjusted by changing the activator concentration at a given temperature. The curing time may be from minutes to several hours. FIG. 7 depicts the viscosity vs. time for different formulations at 200 °F. An increase in activator concentration reduced the gelation time significantly. A novelty of these sealant compositions is that the curing time may be adjusted by changing the activator concentration. A sealant composition formulation comprising a 30 wt. % active alkaline activator solution was prepared from: 100 grams of course date palm seed particles and 200 grams of activated colloidal silica gel (prepared from 60 grams alkaline activator solution (30 wt. % active) and 140 grams of colloidal nanosilica solution (40 wt. % active). The desired curing time is 50 minutes at 200 °F. FIG. 8 shows the date palm seed-silica composite after curing.

In conclusion, the disclosed sealant compositions may improve drilling operations and fluid loss, reduce non-productive time, and reduce the cost of drilling, by enhancing drilling fluid properties such as low circulation. The proposed crushed date palm seeds may be joined with colloidal nanosilica and alkaline activator, to react together after placement in the fracture, to form a rigid material and that having a controlled curing time. This concept has been proven successful and may seal a fracture in a subterranean formation to serve as an efficient lost circulation material that enhances production during subterranean operations, even at elevated temperatures (i.e., 93 °C).

It is to be recognized that the disclosed drilling fluids may also directly or indirectly affect the various downhole equipment and tools that may come into contact with the fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the well site 100 depicted generally in FIG. 1.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as concentration, temperatures, and so forth used in the present specification and associated claims are to be understood as being modified in all instances by the term “about.” As used herein, the term “about” encompasses +/−5% of a numerical value. Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

Terms of orientation are used herein merely for purposes of convention and referencing and are not to be construed as limiting. However, it is recognized these terms could be used with reference to an operator or user.

While the disclosure has described several exemplary embodiments, it will be understood by those skilled in the art that various changes may be made, and equivalents may be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A method comprising:
introducing a sealant composition into a wellbore penetrating a subterranean formation;
wherein the sealant composition comprises:
date palm seed particles; and
an activated colloidal silica gel or a precursor thereof;
heating the sealant composition within the subterranean formation; and
curing the sealant composition upon heating to form a solidified sealant composition;
wherein at least the date palm seed particles and the activated colloidal silica gel or the precursor thereof become polymerized and/or crosslinked with one another during curing.

2. The method of claim 1, wherein the sealant composition is a lost circulation material (LCM) composition;
wherein the LCM composition is introduced into a zone of interest within the subterranean formation via the wellbore;
wherein the LCM composition is cured within the zone of interest.

3. The method of claim 2, wherein the solidified sealant composition formed in the zone of interest mitigates a flow of a fluid from the wellbore into the subterranean formation.

4. The method of claim 1, wherein the sealant composition is a cementing composition;
wherein the cementing composition is introduced into an annulus between a wall of the wellbore and a casing disposed therein; and
wherein the cementing composition is cured within the annulus.

5. The method of claim 1, wherein heating the sealant composition occurs upon contact of the sealant composition with the subterranean formation.

6. The method of claim 1, wherein the activated colloidal silica gel comprises a colloidal nanosilica.

7. The method of claim 1, wherein the precursor is activated with an alkaline activator, and the alkaline activator is selected from the group consisting of alkali metal silicates, alkaline earth metal silicates, alkali metal hydroxides, alkaline earth metal hydroxides, alkali metal carbonates, alkaline earth metal carbonates, alkali metal sulfates, alkaline earth metal sulfates, alkali metal oxides, alkaline earth metal oxides, and any combination thereof.

8. The method of claim 1, wherein the sealant composition further comprises a set retarding agent.

9. (canceled)

10. The method of claim 1, wherein the solidified sealant composition mitigates a flow of a fluid through the solidified sealant composition at a pressure of 1500 psi and at a temperature of about 200°F, for up to 45 minutes.

11. The method of claim 1, further comprising: prior to introducing the sealant composition to the zone of interest,
pulverizing date palm seeds to form the date palm seed particles;
segregating the date palm seed particles by size;
blending colloidal silica and an alkaline activator with one another to form the activated colloidal silica gel; and
impregnating at least a portion of the date palm seed particles with the activated colloidal silica gel.

12. The method of claim 1, wherein introducing the sealant composition comprises introducing at least one subterranean operation fluid;
wherein the at least one subterranean operation fluid is selected from the group consisting of a drilling fluid, a drilling pill, a cementing slurry, and any combination thereof; and
wherein a single subterranean operation fluid introduces the sealant composition into the wellbore or two or more subterranean operation fluids separately introduce the date palm seed particles and the activated colloidal silica gel or the precursor thereof into the wellbore.

13. A sealant composition, comprising:
date palm seed particles; and
an activated colloidal silica gel, a colloidal silica and an alkaline activator, or any combination thereof;
wherein the sealant composition is capable of curing upon heating to form a solidified sealant composition.

14. The sealant composition of claim 13, wherein the colloidal silica comprises a colloidal nanosilica.

15. The sealant composition of claim 13, wherein the alkaline activator is selected from the group consisting of alkali metal silicates, alkaline earth metal silicates, alkali metal hydroxides, alkaline earth metal hydroxides, alkali metal carbonates, alkaline earth metal carbonates, alkali metal sulfates, alkaline earth metal sulfates, alkali metal oxides, alkaline earth metal oxides, and any combination thereof.

16. The sealant composition of claim 13, wherein the sealant composition further comprises a set retarding agent.

17. The sealant composition of claim 13, wherein the sealant composition is capable of curing upon contact of the sealant compositions upon heating at a temperature of from 120°F to 400°F.

18. The sealant composition of claim 13, wherein the sealant composition has a curing time, at a temperature of 200 °F, of at least 50 minutes (min).

19. The sealant composition of claim 13, wherein the solidified sealant composition is capable of mitigating a flow of a fluid through the solidified sealant composition at a pressure of 1500 psi and at a temperature of about 200°F, for at least 40 minutes.
